(19) United States
(12) Patent Application Publication
(10) Pub. No.: US 2005/0007942 A1
(43) Pub. Date: Jan. 13, 2005

(54) Optical recording medium, process for the production thereof, master stamper for optical recording medium and process for the production thereof

(75) Inventors: Takashi Horai, Tokyo (JP); Yuichi Kawaguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/886,591

(22) Filed: Jul. 9, 2004

(30) Foreign Application Priority Data
Jul. 10, 2003 (JP) 2003-272965

(51) Int. Cl. G11B 7/24; G11B 7/00

(52) U.S. Cl. 369/275.4; 369/111

(57) ABSTRACT

The optical recording medium comprises a light-transmitting substrate 11 having a spiral groove 11a formed thereon and a recording layer 21 containing an organic dye wherein the average inclination angle θa of the wall of the groove 11a on the inward side thereof is greater than the average inclination angle θb of the wall of the groove on the outward side thereof. In this arrangement, when the recording layer 21 is formed by a spin coating method, the dispersion of the thickness of the recording layer 21 inside the groove 11a can be prevented, making it assured that the recording layer 21 can be provided with a desired thickness over an area inside the groove 11a ranging from the inward side thereof to the outward side thereof. As a result, heat of laser beam emitted during recording can be almost uniformly dissipated over the area inside the groove ranging from the inward side to the outward side thereof to eliminate the effect of thermal interference between marks, making it possible to secure a wide power margin during a high speed recording.

### BACKGROUND OF THE INVENTION

The present invention relates to an optical recording medium and a process for the production thereof and more particularly to a write-once-read-many type optical recording medium comprising a recording layer formed thereon by a spin coating method and a process for the production thereof. The present invention also relates to a master (stamper) for optical recording medium for use in the production of such an optical recording medium and a process for the production thereof.

In recent years, as recording media for recording a large volume of digital data there have been widely used optical recording media represented by CD (compact disc) and DVD (digital versatile disc) . These optical recording media can be roughly divided into three groups, i.e., optical recording medium of type capable of neither writing nor rewriting data such as CD-ROM and DVD-ROM (ROM type optical recording medium), optical recording medium of type capable of writing once data but incapable of rewriting data such as CD-R and DVD-R (write-once-read-many type optical recording medium) and optical recording medium of type capable of rewriting data such as CD-RW and DVD-RW (rewritable optical recording medium).

As well known, ROM type optical recording media normally employs a process involving the recording of data by pits formed on the substrate during production. Rewritable optical recording media normally comprise a recording layer made of, e.g., a phase-change material which shows phase change causing the change of optical properties that is then used for data recording.

On the other hand, write-once-read-many type optical recording media normally comprise a recording layer made of an organic material which shows irreversible chemical change (occasionally accompanied by physical deformation) causing the change of optical properties that is then used for data recording. The irreversible chemical change of the organic dye normally occurs when the organic dye is irradiated with laser beam having a predetermined intensity or more, making it possible to form desired recording marks on the recording layer. Examples of the organic dye employable include various organic dyes such as cyanine dye, phthalocyanine dye and azo dye. One or more optimum organic dyes may be selected depending on the required properties.

In order to produce a write-once-read-many type optical recording medium, a master for optical recording medium is used to prepare a substrate having a spiral groove. Subsequently, a coating solution having the organic dye dissolved therein is spin-coated (rotary coating) on the surface of the substrate having a groove formed thereon to form a recording layer thereon. The subsequent steps differ with the kind of the optical recording medium to be prepared. In order to produce CD-R for example, a reflective layer and a protective layer can be formed on the recording layer to complete the optical recording medium. In order to produce DVD-R, a dummy substrate can be laminated on the substrate which has a recording layer and a protective layer formed on the recording layer with an adhesive to complete the optical recording medium (see Patent References 1 and 2).

[Patent Reference 1] JP-A-2-147286

[Patent Reference 2] JP-A-11-86344

In general, write-once-read-many type optical recording media are optimized in the thickness of recording layer, the kind of organic dye to be incorporated therein, the depth of groove to be provided on the substrate, etc. to provide good properties when data recording is conducted under predetermined conditions. Representative examples of the predetermined conditions include recording linear speed and recording power (Pw) of laser beam. When data recording is actually conducted, adjustment is made on the part of the recording device (drive) so as to meet these requirements.

However, the accuracy of operation of the recording device is somewhat limited. Further, the optical recording media are subject to deformation such as warp or dispersion in production conditions. It is therefore desirable that the aforementioned predetermined conditions be as wide as possible. In other words, the margin of various recording properties is preferably wide.

The margin of various recording properties normally tends to be short when a high speed recording is conducted. For example, when a high speed recording is made on a write-once-read-many type optical recording medium comprising a recording layer made of an organic dye, it is naturally necessary that the recording power of laser beam be raised, causing remarkable occurrence of thermal interference between recording marks. As a result, a problem arises that the tolerance of recording properties for the power of laser beam (power margin) tends to be short.

### SUMMARY OF THE INVENTION

An aim of the invention is to provide a write-once-read-many type optical recording medium having an improvement in the margin of various recording properties, particularly the power margin of laser beam during high speed recording, and a process for the production thereof.

Another aim of the invention is to provide a master for optical recording medium for use in the production of a substrate for such a write-once-read-many type optical recording medium and a process for the production thereof.

The recording properties of a write-once-read-many type optical recording medium are greatly affected by the thickness of the recording layer, the depth of groove provided on the substrate, etc. Therefore, in order to adjust various margins, it is essential that these factors be optimized. However, as a result of extensive studies made by the inventors, it was found that even if these factors are optimized, the recording properties show a slight change depending on the profile of the groove provided on the substrate. The invention has been worked out on the basis of this technical knowledge.

The optical recording medium according to the invention comprises a substrate having a spiral groove formed on at least one surface thereof and a recording layer containing an organic dye formed on the surface of the substrate on the side thereof where the groove is formed, wherein the average inclination angle of the wall of the groove on the inward side thereof is greater than that of the wall of the groove on the outward side thereof. In accordance with the configuration of the optical recording medium of the invention, the dispersion of the thickness of the recording layer inside the groove can be minimized during the formation of the recording layer by a spin-coating method, making it possible to provide the recording layer with a desired thickness over the area inside the groove ranging from the inward side to the outward side thereof. As a result, heat of laser beam emitted during recording can be almost uniformly dissipated over the area inside the groove ranging from the inward side to the outward side thereof to enhance the recording sensitivity and eliminate the effect of thermal interference between marks, making it possible to secure a wide power margin during a high speed recording.

It is also preferred that a reflective layer be provided on the substrate on the side thereof opposite the recording layer. Since the reflective layer also acts as a radiating layer for radiating heat of laser beam emitted to the recording layer, heat of laser beam emitted during recording can be almost uniformly radiated toward the reflective layer over the area inside the groove ranging from the inward side to the outward side thereof.

In the invention, the groove may wobble with a predetermined amplitude. In this case, it is preferred that the inclination angle of the wall of the groove on the inward side thereof be greater than that of the wall of the groove on the outward side thereof at the center of-the amplitude. In this arrangement, even when a portion having a wall which is steeper on the outward side thereof than on the inward side thereof exists in some area, the wall is steeper on the inward side of the groove than on the outward side of the groove on substantially more than half the area of the groove. As a result, the average inclination angle of the wall of the groove on the inward side thereof can be made greater than that of the wall of the groove on the outward side thereof. However, it is preferred that the inclination angle of the wall of the groove on the inward side thereof be greater than that of the wall of the groove on the outward side thereof even at the portion at which the groove wobbles most outward.

The process for the production of an optical recording medium according to an aspect of the invention comprises a first step of exposing a photoresist master to light with the axis of exposing laser beam inclined toward the inward side of the photoresist master on the average, a second step of transferring the pattern thus formed on the photoresist master by exposure to prepare a master for optical recording medium, a third step of transferring the pattern formed on the master for optical recording medium to prepare a substrate having a groove and a fourth step of spin-coating a solution containing an organic dye onto the surface of the surface of the substrate on the side thereof having the groove formed thereon. In this manner, the average inclination angle of the wall of the groove formed on the substrate on the inward side thereof is greater than that of the wall of the groove on the outward side thereof, making it possible to minimize the dispersion of the thickness of the recording layer inside the groove formed by a spin coating method and hence provide the recording layer with a desired thickness over the area inside the groove ranging from the inward side thereof to the outward side thereof. As a result, heat of laser beam emitted during recording can be almost uniformly dissipated over the area inside the groove ranging from the inward side thereof to the outward side thereof, making it possible to produce an optical recording medium having a high recording sensitivity and a wide power margin.

In this case, it is preferred that the average angle of deflection of the exposing laser beam toward the inward side of the photoresist master at the first step be predetermined to be from greater than 0° to not greater than 0.00045°, more preferably from greater than 0.0001° to not greater than 0.0003°, particularly about 0.0002°. When the angle of deflection of the exposing laser beam is predetermined as defined above, the groove formed on the substrate can be certainly provided with the aforementioned profile and the deformation of beam spot by the deflection of the exposing laser beam can fall within the tolerance, making it possible to keep a proper exposed state. Thus, the optimized state of the groove cannot be impaired. In other words, the advantage of the invention and the optimized state can be fairly balanced.

Further, the radiation angle of the exposing laser beam may be varied at the first step to form an exposure pattern wobbling with a predetermined amplitude. In this case, it is preferred that the angle of deflection of the exposing laser beam toward the inward side of the photoresist master be predetermined to be from greater than 0° to not greater than 0.00045° during the exposure of the portion of the exposure pattern corresponding to the center of the amplitude to light. It is more desirable that the angle of deflection of the exposing laser beam toward the inward side of the photoresist master be predetermined to be from greater than 0° to not greater than 0.00045° during the exposure of the portion of the photoresist master corresponding to the portion at which the groove wobbles most outward.

The process for the production of an optical recording medium according to another aspect of the invention comprises a first step of preparing a substrate having a spiral groove using a master for optical recording medium having a spiral raised pattern wherein the average angle of inclination of the wall of the raised pattern on the inward side thereof is greater than that of the wall of the raised pattern on the outward side thereof and a second step of spin-coating a solution containing an organic dye onto the surface of the surface of the substrate on the side thereof having the groove formed thereon. In this case, too, the average angle of inclination of the wall of the groove formed on the substrate on the inward side thereof can be made greater than that of the wall of the groove on the outward side thereof. Therefore, for the reason mentioned above, an optical recording medium having a high recording sensitivity and a wide power margin can be produced.

The master for optical recording medium according to the invention is a master for optical for use in the preparation of a substrate for optical recording medium wherein there is provided a spiral raised pattern on the surface thereof and the average angle of inclination of the wall of the raised pattern on the inward side thereof is greater than that of the wall of the raised pattern on the outward side thereof. The process for the production of a master for optical recording medium according to the present invention comprises a first step of exposing a photoresist master to light with the axis of exposing laser beam inclined toward the inward side of the photoresist master on the average and a second step of transferring the pattern thus formed on the photoresist master by exposure to prepare a master for optical recording medium. When such a master for optical recording medium is used to prepare an optical recording medium, the average inclination angle of the wall of the groove formed on the substrate on the inward side thereof can be made greater than that of the wall of the groove on the outward side thereof. Therefore, for the reason mentioned above, an optical recording medium having a high recording sensitivity and a wide power margin can be produced.

In accordance with the invention, a high recording sensitivity and a wide power margin can be obtained. This effect can be exerted remarkably during a high speed recording. Thus, the invention can provide an optical recording medium suitable for high speed recording. Further, since this effect can be exerted by adjusting the incidence angle of the exposing laser beam during cutting of the photoresist master, it causes no cost rise as compared with the related art technique.

### BRIEF DESCRIPTION OF THE DRAWINGS

FIG. 1A is a broken perspective view illustrating the external appearance of an optical recording medium 10 according to a preferred embodiment of implementation of the invention;

FIG. 1B is an enlarged partial sectional view of the part A of FIG. 1A;

FIG. 2 is an enlarged sectional view illustrating in detail the surface profile of a light-transmitting substrate 11;

FIG. 3 is a typical top plan view of a wobbling groove 11a;

FIG. 4A illustrates the sectional profile of the portion 41 at which the groove 11a wobbles most outward;

FIG. 4B illustrates the sectional profile of the central portion 42 of the amplitude;

FIG. 4C illustrates the sectional profile of the portion 43 at which the groove 11a wobbles most inward;

FIG. 5 is a diagram illustrating the thickness of a recording layer 21 inside the groove 11a;

FIG. 6 is a schematic configurational view illustrating an example of a cutting device for cutting the photoresist master;

FIG. 7 is a diagram illustrating the deflection of the axis of exposing laser beam 121a;

FIG. 8 is a partial sectional view taken along the radial direction of the photosensitive material layer 202 which has been exposed to have a latent image formed thereon;

FIG. 9 is a diagram illustrating the deflection of the axis of exposing laser beam 121a in the case where the latent image 203 is allowed to wobble;

FIGS. 10A to 10E are flow charts illustrating a process for the production of a master for optical recording medium 210;

FIG. 11 is an enlarged sectional view illustrating in detail the surface profile of the master for optical recording medium 210;

FIGS. 12A to 12C are flow charts illustrating a process for the production of an optical recording medium 10;

FIGS. 13A to 13C are flow charts illustrating the rest of the process for the production of an optical recording medium 10;

FIG. 14 is a graph illustrating the relationship between the recording power (Pw) and asymmetry of laser beam 30 in the evaluation 1 of properties;

FIG. 15 is a graph illustrating the relationship between the recording power (Pw) and asymmetry of laser beam 30 in the evaluation 2 of properties; and

FIG. 16 is a graph illustrating the relationship between the asymmetry and error rate in the evaluation 2 of properties.

### DETAILED DESCRIPTION OF THE PREFERRED EMBODIMENTS

A preferred embodiment of implementation of the invention will be described in detail in connection with the attached drawings.

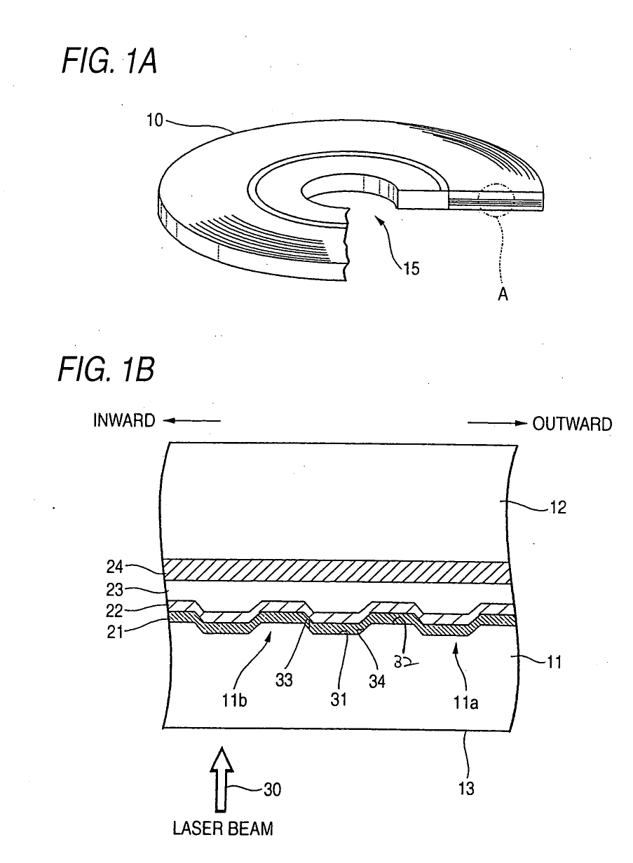

FIG. 1A is a broken perspective view illustrating the external appearance of an optical recording medium 10 according to a preferred embodiment of implementation of the invention. FIG. 1B is an enlarged partial sectional view of the part A of FIG. 1A.

The optical recording medium 10 according to the present embodiment is a so-called DVD-R type optical recording medium (write-once-read-many type optical recording medium). As shown in FIG. 1A, the external appearance of the optical recording medium 10 is a disc having a hole 15 provided in the center thereof. The diameter of the optical recording medium 10 is not specifically limited but is preferably predetermined to about 120 mm.

The optical recording medium 10 comprises a light-transmitting substrate 11, a dummy substrate 12, and a recording layer 21, a reflective layer 22, a protective layer 23 and an adhesive layer 24 provided interposed therebetween as shown in FIG. 1B. The recording and reproduction of data can be carried out by irradiating the optical recording medium 10 with laser beam 30 on the light incidence surface 13 side thereof while the optical recording medium 10 is being rotated. Though not specifically limited, the wavelength of laser beam 30 can be predetermined to about 660 nm and the aperture of the objective lens for converging laser beam 30 can be predetermined to about 0.65.

The light-transmitting substrate 11 is a disc-shaped substrate made of a material having a sufficiently high transmittance of light in the wavelength of laser beam 30. One surface (lower surface as viewed on FIG. 1) of the substrate 11 forms a light incidence surface 13 on which laser beam 30 is incident and the other surface (upper surface as viewed on FIG. 1) of the substrate 11 has a groove 11a and a land 11b spirally formed thereon extending from the point close to the center of the disc toward the outer edge thereof or vice versa for guiding laser beam 30. The light-transmitting substrate 11 acts as a light path through which laser beam 30 emitted during recording and reproduction of data passes and a base for assuring the mechanical strength required for the optical recording medium 10. Though not specifically limited, the thickness of the light-transmitting substrate 11 is preferably predetermined to about 0.6 mm and the light-transmitting substrate 11 is preferably made of a resin from the standpoint of formability. Examples of such a resin include polycarbonate resins, olefin resins, acrylic resins, epoxy resins, polystyrene resins, polyethylene resins, polypropylene resins, silicone resins, fluororesins, ABS resins, and urethane resins. Particularly preferred among these resins are polycarbonate resins and olefin resins because they have excellent optical properties and workability.

The depth and half-width of the groove 11a may be optimized depending on the kind of the organic dye constituting the recording layer 21 or other factors but may be actually predetermined to about 160 nm and from not smaller than 300 nm to not greater than 350 nm, respectively. The wall surfaces 33 and 34 connecting between the bottom 31 of the groove 11a and the upper surface 32 of the land 11b are not perpendicular to the bottom of the groove 11a (or the upper surface of the land 11b) but are oblique thereto at a predetermined angle as shown in FIG. 1B. This configuration will be further described later.

The dummy substrate 12 is a disc-shaped substrate which acts to increase the mechanical strength of the optical recording medium 10 and provide the optical recording medium 10 with a required thickness (e.g., about 1.2 mm). Though not specifically limited, the thickness of the dummy substrate 12 is predetermined to about 0.6 mm similarly to the light-transmitting substrate 11. As the material of the dummy substrate 12 there may be used any material such as glass, ceramics and resin. Unlike the light-transmitting substrate 11, however, the dummy substrate 12 doesn't act as a light path for laser beam 30 and thus doesn't need to have a high light transmittance. Nevertheless, the dummy substrate 12, too, is preferably made of a polycarbonate resin or olefin resin from the standpoint of workability or the like.

The recording layer 21 is a layer mainly composed of an organic dye which forms recording marks thereon when irradiated with laser beam 30. When irradiated with laser beam 30 having a power predetermined to not smaller than required level, the recording layer 21 causes the organic dye which is a main component to undergo decomposition and modification resulting in the change of optical constant. The region on the recording layer 21 which underwent decomposition and modification is used as a “recording mark (pit)” while the other region is used as a “blank region”. Data recorded are represented by the length of the recording mark (length between the forward edge and the rear edge of the recording layer and the length of the blank region (length between the rear edge of a recording mark and the forward edge of the subsequent recording mark). Supposing that the length corresponding to one cycle of clock which is a reference is T, all these data are predetermined to an integral multiple of T. In some detail, DVD-R employs an 8/16 modulation system involving the use of recording marks and blank regions having a length of 3T to 11T and 14T.

The kind of the organic dye constituting the recording layer 21 is not specifically limited but may be a cyanine-based dye, phthalocyanine-based dye, azo dye or the like. Since the recording layer 21 is formed by a spin coating method as described later, the thickness of the recording layer 21 normally differs from at the portion of the groove 11a to at the portion of the land 11b. The actual thickness of the recording layer 21 may be optimized depending on the kind of the organic dye used but may be predetermined to from not smaller than 30 nm to not greater than 300 nm at the portion of the groove 11a.

The reflective layer 22 is provided to reflect laser beam 30 which has passed through the light-transmitting substrate 11 and the recording layer 21 during the reproduction of data from the optical recording medium 10. The material of the reflective layer 22 is not specifically limited so far as it is capable of reflecting laser beam 30. Examples of the material of the reflective layer 22 employable herein include magnesium (Mg), aluminum (Al), titanium (Ti), chromium (Cr), iron (Fe), cobalt (Co), nickel (Ni), copper (Cu), zinc (Zn), germanium (Ge), silver (Ag), platinum (Pt), gold (Au), and alloy thereof. Preferred among these materials are aluminum (Al), gold (Au), silver (Ag), copper (Cu) and alloy thereof, particularly alloy mainly composed of silver (Ag), because they have a high reflectance. The thickness of the reflective layer 22 is not specifically limited and may be predetermined to from not smaller than 50 nm to not greater than 200 nm.

The protective layer 23 is a layer provided to protect the recording layer 21 and the reflective layer 22 provided on the light-transmitting substrate 11. The protective layer 23 is formed covering the surface of the reflective layer 22. The material and thickness of the protective layer 23 are not specifically limited so far as the protective layer 23 can physically and chemically protect the recording layer 21 and the reflective layer 22. In practice, however, the material of the protective layer 23 is preferably an ultraviolet-curing resin such as acrylic resin and epoxy resin and the thickness of the protective layer 23 is preferably predetermined to from not smaller than 0.5 μm to not greater than 100 μm.

The adhesive layer 24 is a layer for bonding a laminate of the light-transmitting substrate 11, the recording layer 21, the reflective layer 22 and the protective layer 23 to the dummy substrate 12. The adhesive layer 24 may be made of an ultraviolet-curing adhesive or the like. The thickness of the adhesive layer 24 is not specifically limited so far as the adhesive layer 24 can certainly bond the laminate to the dummy substrate 12 and may be predetermined to from not smaller than 10 μm to not greater than 200 μm.

The basic configuration of the optical recording medium 10 has been described hereinabove. The surface profile of the light-transmitting substrate 11 will be described in detail hereinafter.

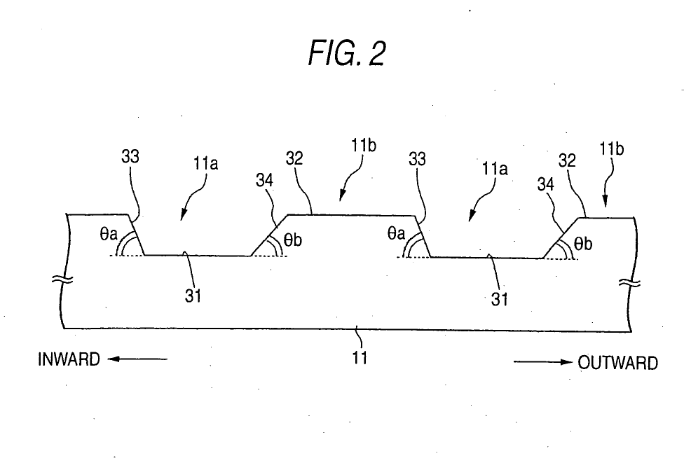

FIG. 2 is an enlarged sectional view illustrating in detail the surface profile of the light-transmitting substrate 11.

As shown in FIG. 2, the optical recording medium 10 according to the present embodiment is arranged such that the inward wall 33 and the outward wall 34 which connect between the bottom 31 of the groove 11a and the upper surface 32 of the land 11b have different inclination angles. In some detail, supposing that the angle of inclination (<90°) of the inward wall 33 and the outward wall 34 with respect to the bottom 31 of the groove 11a are θa and θb, respectively, it is predetermined in the present embodiment that θa is greater than θb. In other words, the inward wall 33 is steeper than the outward wall 34.

It is most desirable that the aforementioned relationship between the inclination angle θa of the inward wall 33 and the inclination angle θb of the outward wall 34 be satisfied over the entire region of the groove 11a. However, it suffices if the aforementioned relationship is satisfied over at least half the entire region of the groove 11a. In other words, even when there are some regions where θa equals to or is smaller than θb, it suffices only if the aforementioned relationship (θa>θb) is satisfied over substantially not smaller than half the entire region of the groove 11a. In short, it suffices if the average inclination angle θa (ave) of the inward wall 33 is greater than that of the outward wall 34 as viewed generally on the groove 11a. The difference in the relationship between the inclination angle θa of the inward wall 33 and the inclination angle θb of the outward wall 34 from position to position in the groove 11a occurs mainly when the groove 11a is formed with wobbling.

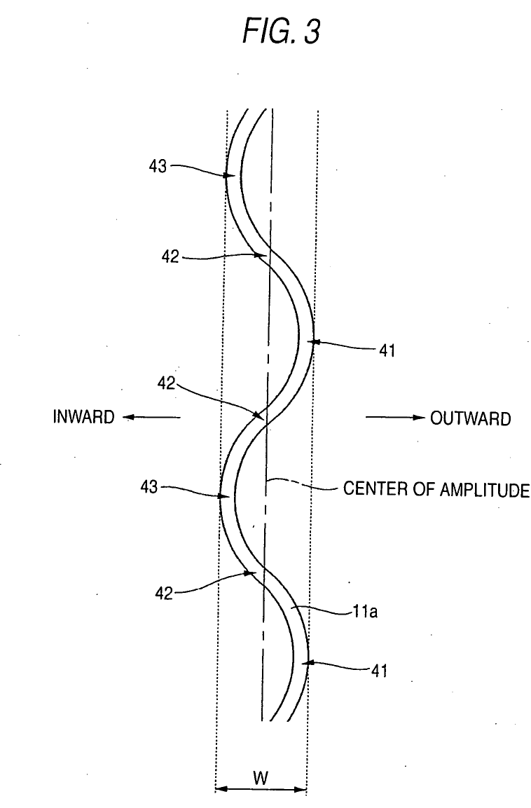

FIG. 3 is a typical top plan-view of a wobbling groove 11a. As shown in FIG. 3, in the case where the groove 11a wobbles with a predetermined amplitude W, the groove 11a has a repetition of portions 41 at which the groove 11a wobbles most outward, central portions 42 of the amplitude and portions 43 at which the groove 11a wobbles most inward.

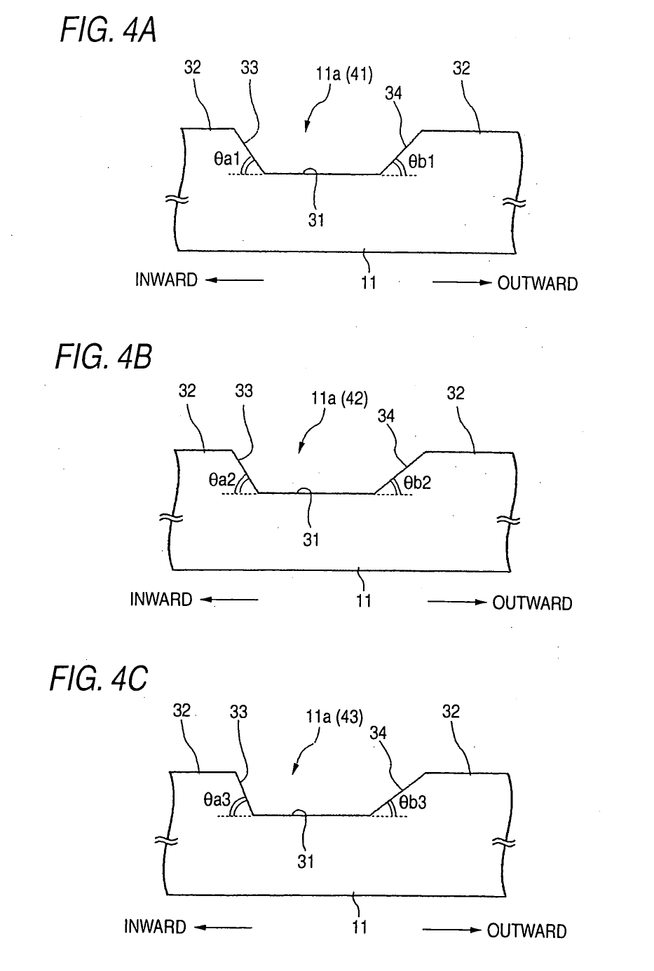

FIG. 4 is a diagram illustrating the sectional profile of the groove 11a at portions (41, 42, 43) wherein FIG. 4A illustrates the sectional profile of the portion 41 at which the groove 11a wobbles most outward, FIG. 4B illustrates the sectional profile of the central portion 42 of the amplitude and FIG. 4C illustrates the sectional profile of the portion 43 at which the groove 11a wobbles most inward.

Supposing that the inclination angle of the inward wall 33 and the outward wall 34 at the portion 41 at which the groove 11a wobbles most outward are θa1 and θb1, respectively, as shown in FIG. 4A, the inclination angle of the inward wall 33 and the outward wall 34 at the central portion 42 of the amplitude are θa2 and θb2, respectively, as shown in FIG. 4B, and the inclination angle of the inward wall 33 and the outward wall 34 at the portion 43 at which the groove 11a wobbles most inward are θa3 and θb3, respectively, as shown in FIG. 4C, the relationships θa1<θa2 <θa3 and θb1>θb2>θb3 are normally established. In other words, the more outward the groove 11a wobbles, the smaller is the inclination angle θa of the inward wall 33 and the greater is the inclination angle θb of the outward wall 34. On the contrary, the more inward the groove 11a wobbles, the greater is the inclination angle θa of the inward wall 33 and the smaller is the inclination angle θb of the outward wall 34. This is attributed to the change of incidence angle of the exposing laser beam during cutting of the photoresist master. This will be further described later.

In the case where the groove 11a wobbles as mentioned above, it is necessary in the invention that at least the relationship θa2>θb2 be satisfied. In other words, it is necessary that the inclination angle θa2 of the inward wall 33 be greater than the inclination angle θb2 of the outward wall 34 at the central portion 42 of the amplitude. So far as this requirement is satisfied, even if there are some areas where θa equals to or is smaller than θb, the relationship θa >θb can be established over substantially not smaller than half the entire region of the groove 11a. As a result, the average inclination angle θa (ave) of the inward wall 33 is greater than the average inclination angle θb(ave) of the outward wall 34.

However, even when the groove 11a wobbles, it is most desirable that the relationship θa>θb be satisfied over the entire region of the groove 11a. This means that the relationship θa3>θb3 is satisfied.

The configuration of the optical recording medium 10 according to the present embodiment has been described hereinabove. This configuration makes it possible to increase the power margin particularly during high speed recording as compared with the related art optical recording media. The reason for this advantage is not necessarily made obvious but is probably as follows.

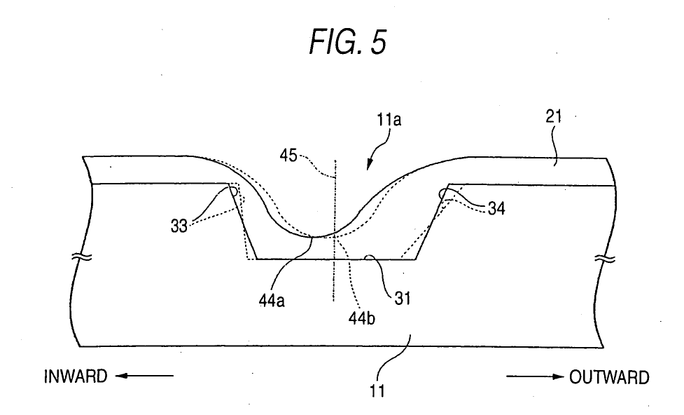

Since the formation of the recording layer 21 mainly composed of an organic dye is normally carried out by a spin coating method, the thickness of the recording layer 21 thus formed is not strictly uniform, causing the presence of thick portions and thin portions inside the groove 11a. FIG. 5 is a schematic sectional view illustrating this defect. The profile of the light-transmitting substrate 11 and the recording layer 21 in the case where the inclination angle θa of the inward wall 33 equals to the inclination angle θb of the outward wall 34 (θa=θb) and in the case where the inclination angle θa of the inward wall 33 is greater than the inclination angle θb of the outward wall 34 (θa>θb) are represented by solid line and broken line, respectively.

As shown in FIG. 5, in the case where the inclination angle θa of the inward wall 33 equals to the inclination angle θb of the outward wall 34 (shown by solid line), the portion 44a at which the recording layer 21 has the greatest thickness inside the groove 11a is slight inward as viewed from the center 45 of the groove 11a. This is attributed to the fact that the formation of the recording layer 21 by a spin coating method involves the generation of centrifugal force that causes the coating solution to be spread from the inward side of the light-transmitting substrate 11 toward the outward side of the light-transmitting substrate 11, giving a tendency that the coating solution can be more easily accumulated outward as viewed from the center 45 of the groove 11a. Accordingly, the recording layer 21 is relatively thick on the outward side as viewed from the center 45 of the groove 11a, causing heat of laser beam 30 emitted during recording to be dissipated differently from inward side to outward side. This probably causes the reduction of power margin particularly during high speed recording.

On the contrary, in the case where the inclination angle θa of the inward wall 33 is greater than the inclination angle θb of the outward wall 34 (shown by broken line), the coating solution can be difficultly accumulated on the outward side as viewed from the center 45 of the groove 11a, causing the substantial coincidence of the portion 44b at which the recording layer 21 has the smallest thickness inside the groove 11a with the center 45 of the groove 11a. In other words, the thickness of the recording layer 21 is almost constant inside the groove 11a. As a result, heat of laser beam 30 emitted during recording can be almost uniformly and efficiently dissipated toward the reflective layer 22 over the area inside the groove 11a ranging from inward side to outward side, causing the increase of power margin particularly during high speed recording.

A process for the production of the light-transmitting substrate 11 having the aforementioned profile will be described hereinafter.

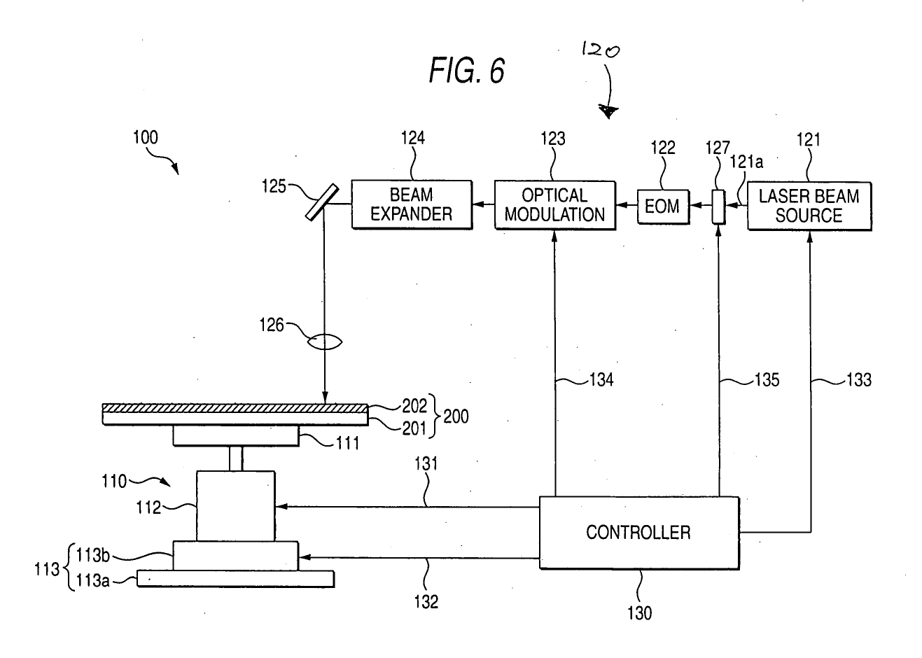

FIG. 6 is a schematic configurational diagram illustrating an example of the cutting device for cutting a photoresist master.

The cutting device 100 shown in FIG. 6 comprises a driving portion 110 for rotating and moving horizontally a photoresist master 200, an optical system 120 for handling exposing laser beam and a controller 130 for controlling the entire device. The photoresist master 200 to be cut is composed of a glass substrate 201 and a photosensitive material layer 202 formed on the surface thereof. The thickness of the photosensitive material layer 202 is normally predetermined to from not smaller than 10 nm to not greater than 200 nm. The photoresist master 200 may have an adhesive layer (primer) provided interposed between the glass substrate 201 and the photosensitive material 202 for enhancing the adhesion therebetween.

The driving portion 110 comprises a turn table 111 for resting the photoresist master 200 thereon, a spindle motor 112 for rotating the turn table 111 and a sliding mechanism 113 for moving the portion consisting of the turn table 111 and the spindle motor 112 in the horizontal direction. The sliding mechanism 113 is formed by a rail 113a fixed to a pedestal (not shown) and a base 113b supporting the portion consisting of the turn table 111 and the spindle motor 112. By moving the base 113b along the rail 113a, the portion consisting of the turn table 111 and the spindle motor 112 can be moved in the horizontal direction. The operation of the spindle motor 112 and the sliding mechanism 113 are controlled by control signals 131 and 132 supplied from a controller 130, respectively.

The optical system 120 comprises a laser beam source 121 for emitting exposing laser beam 121a, EOM (Electro Optic Modulator: modulator utilizing an electro-optical effect) 122 for predetermining the power of the exposing laser beam 121a to a value suitable for exposure, an optical modulation unit 123 capable of adjusting the incidence angle of the exposing laser beam 121a, a beam expander 123 for shaping and expanding the diameter of the exposing laser beam 121a, a mirror 125, an objective lens 126 for converging the exposing laser beam 121a and emitting it to the photoresist master 200 and a shutter 127 for blocking the exposing laser beam 121a. The operation of the laser beam source 121, the optical modulation unit 123 and the shutter 127 are controlled by control signals 133, 134 and 135 supplied from the controller 130, respectively.

The configuration of the cutting device 100 has been described hereinabove. A process for cutting the photoresist master 200 using the cutting device 100 will be described hereinafter.

Firstly, the controller 130 uses the control signal 133 to cause the laser beam source 121 to emit exposing laser beam 121a. However, at this point, the shutter 127 is closed by an instruction of the control signal 135. Therefore, the exposing laser beam 121a is blocked by the shutter 127.

Subsequently, the controller 130 uses the control signal 131 to drive the spindle motor 112, causing the turn table 111 to rotate. At the same time, the controller 130 uses the control signal 132 to drive the sliding mechanism 113, causing the coincidence of the position irradiated with the exposing laser beam 121a with the position at which the exposure of the photosensitive material layer 202 begins.

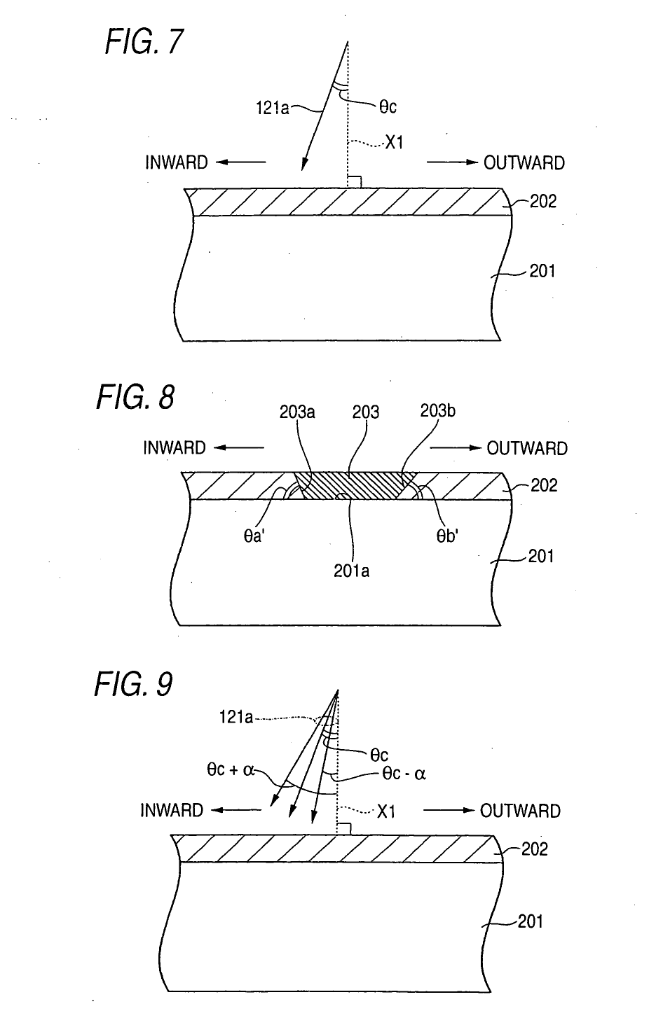

Subsequently, the controller 130 uses the control signal 135 to open the shutter 127. In this manner, the exposing laser beam 121a passes through EOM 122 where it is adjusted to have an intensity suitable for exposure, passes through the optical modulation unit 123 and the beam expander 124, is reflected by the mirror 125, and then applied to the top of the photosensitive material layer 202 through the objective lens 126. In the present embodiment, at this point, the axis of the exposing laser beam 121a applied to the photosensitive material layer 202 is adjusted to be oblique to the surface of the photosensitive material layer 202. In some detail, as shown in FIG. 7, the exposing laser beam is applied to the photosensitive material layer 202 with an inclination at an angle θc with respect to the straight line X1 which is perpendicular to the surface of the photosensitive material layer 202. The adjustment of the incidence angle can be carried out by controlling the optical modulation unit 123 using the control signal 134. The term “the axis of the exposing laser beam 121a is deflected to inward side” as used herein is meant to indicate that the closer to the photosensitive material layer 202 the flux of the exposing laser beam is, the closer to inward side is the horizontal position thereof as shown in FIG. 7.

The controller 130 uses the control signal 132 to drive the sliding mechanism 113 with the exposing laser beam 121a deflected in the aforementioned manner while gradually moving horizontally the sliding mechanism 113 so that a latent image is formed spirally on the photosensitive material layer 202. In this manner, a latent image corresponding to the groove 11a to be formed on the light-transmitting substrate 11 is formed on the photosensitive material layer 202. The direction of movement of exposure is not specifically limited. The exposure may proceed from the inward side to the outward side of the photosensitive material layer 202 or vice versa.

FIG. 8 is a partially sectional view taken along the radial direction of the photosensitive material layer 202 which has been exposed to have a latent image formed thereon. As mentioned above, in the present embodiment, exposure is conducted with the axis of the exposing laser beam 121a deflected to inward side. Therefore, as shown in FIG. 8, the section of the latent image 203 taken along the radial direction differs from inward side to outward side and thus is steeper on the inward side. In some detail, supposing that the angle of inclination (<900) of the inward wall 203a and the outward wall 203b of the latent image 203 with respect to the surface 201a of the glass substrate 201 are θa′ and θb′, respectively, the relationship θa′>θb′ is established in the present embodiment. The inclination angles θa′ and θb′ of the inward wall 203a and the outward wall 203b of the latent image 203, respectively, are finally coincident substantially with the inclination angles θa and θb of the inward wall 33 and the outward 34 of the groove 11a.

The specific value of the angle θc of the exposing laser beam 121a is preferably predetermined to from more than 0° to not greater than 0.00045°, more preferably from more than 0.0001° to not greater than 0.0003°, particularly about 0.0002°. When the angle θc of the exposing laser beam 121a is predetermined to from more than 0° to not greater than 0.00045°, the profile of the groove on the finally prepared light-transmitting substrate 11 can meet the relationship θa>θb. At the same time, since the deformation of beam spot by the deflection of the exposing laser beam 121a falls within the toleration, a proper exposed state can be assured and the state optimized by the depth and half-width of the groove 11a cannot be impaired. In other words, when the angle θc of the exposing laser beam 121a is raised, the inclination angle θa of the groove 11a can be raised and the inclination angle θb of the groove 11a can be reduced, but the deformation of beam spot by the deflection of the exposing laser beam 121a is increased, occasionally impairing the state optimized by the depth and half-width of the groove 11a and hence making it likely that the recording properties can be deteriorated. However, when the angle θc of the exposing laser beam 121a is predetermined to not greater than 0.00045°, such a problem occurs little. Further, when the angle θc of the exposing laser beam 121a is predetermined to from more than 0.0001° to not greater than 0.0003°, the advantage of the invention and the optimized state can be fairly balanced. When the angle θc of the exposing laser beam 121a is predetermined to about 0.0002°, they can be optimally balanced.

It is most desirable that the angle θc of the exposing laser beam 121a always falls within the above defined range during cutting. When it is necessary that the angle θc of the exposing laser beam 121a be varied during cutting, it suffices if the average angle θc (ave) of the exposing laser beam 121a during cutting falls within the above defined range. The variation of the angle θc of the exposing laser beam 121a during cutting is necessary in the case where the groove 11a on the light-transmitting substrate 11 to be prepared is allowed to wobble.

In other words, in order to allow the groove 11a on the light-transmitting substrate 11 to wobble, the latent image 203 formed on the photosensitive material layer 202, too, must be allowed to wobble. In order to allow the latent image 203 to wobble, it is necessary that the exposing laser beam 121a be caused to wobble during cutting by controlling the optical modulation unit 123 by the control signal 134. During this process, the angle θc of the exposing laser beam 121a undergoes variation. In this case, when the angle θc of the exposing laser beam 121a falls within the above defined range during the exposure of the portion corresponding to the center of the amplitude of wobbling, the average angle θc (ave) of the exposing laser beam 121a during cutting, too, is allowed to fall within the above defined range. In other words, it suffices if the exposing laser beam 121a is deflected to inward side during the exposure of the portion corresponding to the center of the amplitude of wobbling and the exposing laser beam 121a wobbles inward and outward with this point as a center as shown in FIG. 9. When the exposing laser beam 121a is caused to wobble, the exposing laser beam 121a is deflected at an angle of θc+a° during the exposure of the portion at which the exposing laser beam 121a wobbles most inward and is deflected at an angle of θc−a° during the exposure of the portion at which the exposing laser beam 121a wobbles most outward. In this case, it is preferred that the exposing laser beam 121a be defected inward (θc>a) also during the exposure of the portion at which the exposing laser beam 121a wobbles most outward.

A process for cutting the photoresist master 200 has been described hereinabove. Thereafter, the photoresist master thus cut is used to prepare a master for optical recording medium.

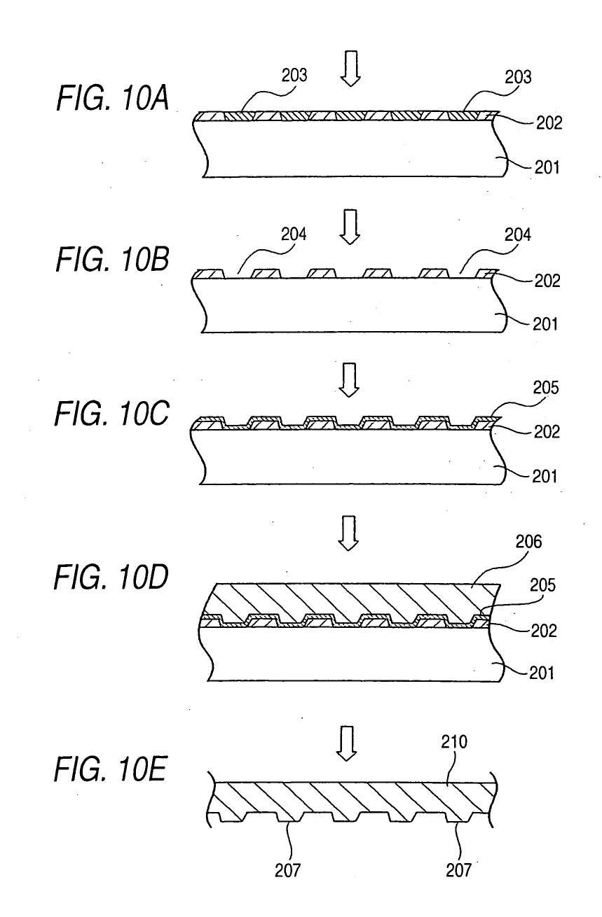

FIGS. 10A to E each are a flow chart illustrating a process for the production of a master for optical recording medium.

As mentioned above, when cutting by the cutting device 100 is completed, a spiral latent image 203 is then formed on the photosensitive material layer 202 of the photoresist master 200 at the area corresponding to the groove 11a (see FIG. 10A). A developer such as sodium oxide solution is then sprayed onto the photoresist master 200 to develop a depressed pattern 204 corresponding to the latent image 203 (see FIG. 10B).

Subsequently, the photosensitive material layer 202 thus developed is subjected to electroless plating or vacuum metallizing to form a thin layer 205 of nickel or the like thereon (see FIG. 10C). The photosensitive material layer 202 is then subjected to thick plating with the surface of the thin metal layer 205 as cathode and nickel as anode to form a thick metal layer 206 thereon to a thickness of, e.g., about 0.3 mm (see FIG. 10D)

Subsequently, the thin metal layer 205 is peeled off the photosensitive material layer 202, and then subjected to cleaning and inner and outer working to complete a master for optical recording medium (stamper) 210 (see FIG. 10E). In this manner, a raised pattern 207 which has been transferred from the depressed pattern 204 is formed on the master for optical recording medium 210. Therefore, when this master for optical recording medium 210 is used to transfer of pattern involving injection molding, 2P method or the like, a light-transmitting substrate having a spiral groove can be mass-produced.

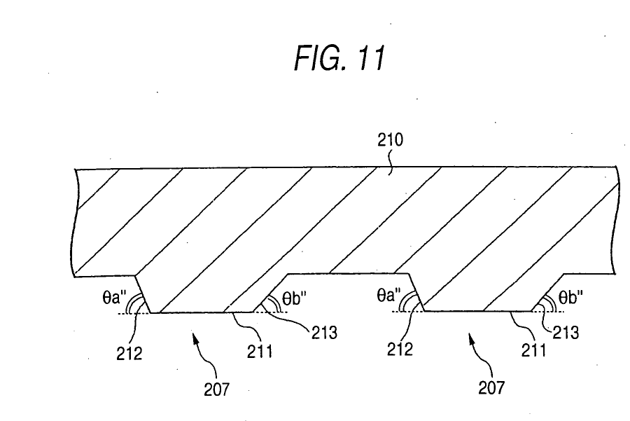

Since the raised pattern 207 on the master for optical recording medium 210 thus prepared reflects directly the profile of the latent image 203 formed on the photosensitive material layer 202, the angle of inclination of the section of the raised pattern 207 differs from on the inward side to on the outward side and the section of the raised pattern 207 is steeper on the inward side as shown in FIG. 11. In other words, supposing that the angle of inclination (<90°) of the inward wall 212 and the outward wall 213 with respect to the flat portion 211 of the raised pattern 207 are θa″ and θb″, respectively, the relationship θa″>b″ can be established. The inclination angles θa″ and θb″ are substantially the same as the inclination angles θa′ and θb′ of the latent image 203, respectively.

A process for the production of the master for optical recording medium 210 using the photoresist master 200 has been described hereinabove.

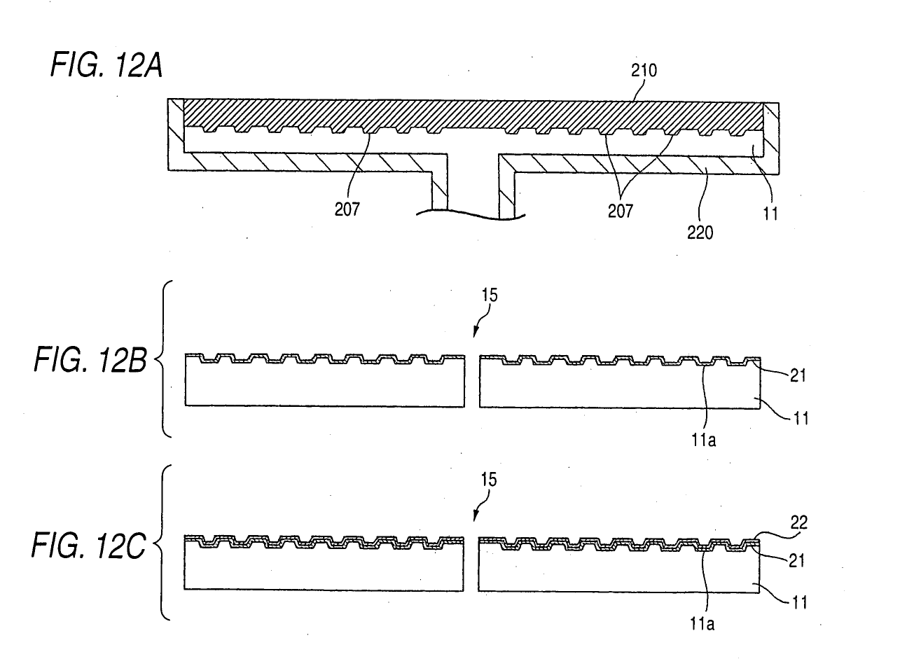

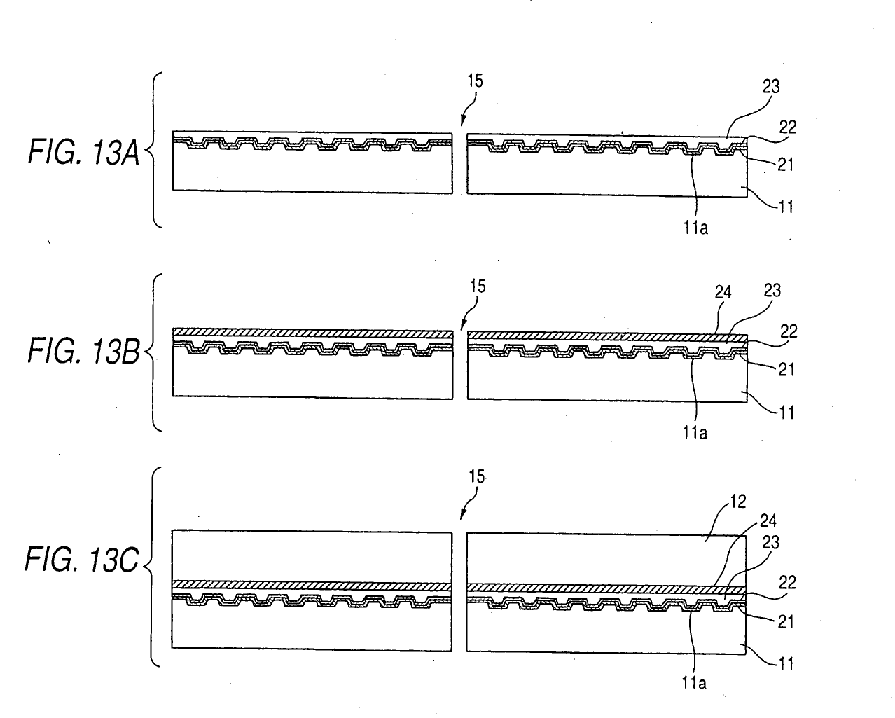

A process for the production of an optical recording medium 10 using the stamper 210 thus prepared will be described hereinafter in connection with FIGS. 12A to 12C and FIGS. 13A to 13C.

Firstly, the stamper 210 thus prepared is mounted on an injection molding machine 220 by which a disc-shaped light-transmitting substrate 11 having a predetermined diameter and thickness (e.g., diameter of about 120 mm and thickness of about 0.6 mm) and having a hole provided at the center thereof is then prepared by injection molding. In this manner, a light-transmitting substrate 11 having a pattern transferred from the raised pattern on the surface of the stamper 210 can be prepared (see FIG. 12A). The depressed portion thus formed by transfer is a groove 11a. Thus, the groove 11a formed on the light-transmitting substrate 11 reflects directly the raised pattern 207 on the stamper 210 (θa″>θb″) . As already described in connection with FIG. 2, the relationship θa>θb can be established. The inclination angles θa and θb are substantially the same as the inclination angles θa′ andθb′ of the raised pattern 207, respectively.

The process for the preparation of the light-transmitting substrate 11 using the stamper 210 is not limited to the aforementioned process. Other processes such as 2P process may be employed.

Subsequently, a recording layer 21 is formed on the light-transmitting substrate 11 on the side thereof having the groove 11a formed thereon by a spin coating method (see FIG. 12B). In some detail, a coating solution containing an organic dye is dropped onto the area close to the center of the light-transmitting substrate 11 which is being rotated so that the resulting centrifugal force causes the coating solution to be spread over the light-transmitting substrate 11 in the outward direction. At this time, the solvent in the coating solution is partially evaporated. Thereafter, when the coating solution is dried, a recording layer 21 substantially composed of an organic dye can be formed almost uniformly on the light-transmitting substrate 11. However, as described in connection with FIG. 5, the thickness of the recording layer 21 is not strictly uniform, causing the presence of thick portions and thin portions inside the groove 11a. In the present embodiment, nevertheless, since the inclination angle θa of the inward wall 33 of the groove 11a is greater than the inclination angle θb of the outward wall 34 of the groove 11a (θa>θb), the thickness of the recording layer 21 is almost uniform inside the groove 11a.

Subsequently, a reflective layer 22 is formed on the surface profile of the recording layer 21 (see FIG. 12C). The formation of the reflective layer 22 can be carried out by a gas phase growth method involving the use of chemical species including the constituents of the reflective layer 22. Examples of the gas phase growth method employable herein include vacuum metallizing, and sputtering. Preferred among these gas phase growth methods is sputtering.

Subsequently, a protective layer 23 is formed on the reflective layer 22 (see FIG. 13A). The formation of the protective layer 23 can be carried out by, e.g., forming an acrylic or epoxy-based ultraviolet-curing resin having an adjusted viscosity into a film by a spin coating method, roll coating method, screen printing method or the like, and then irradiating the film with ultraviolet rays.

Subsequently, an adhesive layer 24 is formed on the protective layer 23 (see FIG. 13B). The formation of the adhesive layer 24, too, can be carried out by a spin coating method, roll coating method, screen printing method or the like.

Subsequently, a dummy substrate 12 is laminated on the adhesive layer 24. The laminate is then irradiated with ultraviolet rays on the dummy substrate side thereof to harden the adhesive layer 24 so that the laminate of light-transmitting substrate 11, recording layer 21, reflective layer 22 and protective layer 23 and the dummy substrate 12 are firmly bonded to each other (see FIG. 13C).

In this manner, the optical recording medium 10 is completed.

A hard coat layer may be provided on the surface of the light-transmitting substrate 11 of the optical recording medium 10 thus prepared to protect the surface of the light-transmitting substrate 11. In this case, the surface of the hard coat layer forms an light incidence surface 13. Examples of the material of the hard coat layer employable herein include an ultraviolet-curing resin containing an epoxy acrylate oligomer (bifunctional oligomer), a polyfunctional acryl monomer, a monofunctional acryl monomer and a photopolymerization initiator, and an oxide, nitride, sulfide or mixture of aluminum (Al), silicon (Si), cerium (Ce), titanium (Ti), zinc (Zn), tantalum (Ta) In the case where the aforementioned ultraviolet-curing resin is used to form the hard coat layer, the ultraviolet-curing resin is preferably spread over the light-transmitting substrate 11 by a spin coating method. In the case where the aforementioned oxide, nitride, sulfide, carbide or mixture thereof is used to form the hard coat layer, a gas phase growth method involving the use of chemical species including these constituents such as sputtering and vacuum evaporation may be effected. Preferred among these gas phase growth methods is sputtering.

The hard coat layer also acts to prevent the light incidence surface 13 from being scratched and thus is preferably not only hard but also lubricant. In order to lubricate the hard coat layer, it is effective to incorporate a lubricant in the matrix of the hard coat layer. As such a lubricant there is preferably selected a silicone-based lubricant, fluorine-based lubricant or aliphatic ester-based lubricant. The content of such a lubricant is preferably from not smaller than 0.1% by weight to not greater than 5.0% by weight.

In order to record data on the optical recording medium 10 thus produced, laser beam 30 which has been intensity-modulated may be incident on the optical recording medium 10 on the light incidence surface 13 thereof while the optical recording medium 10 is being rotated so that the recording layer 21 is irradiated with the laser beam 30 along the groove 11a. Though not specifically limited, the aperture (NA) of the objective lens for converging the laser beam 30 and the wavelength of the laser beam 30 may be predetermined to about 0.65 and about 660 nm, respectively. Referring to the conditions of intensity modulation of laser beam 30, the intensity of the laser beam 30 to be applied to the portion where recording marks should be formed may be predetermined to a sufficiently high recording power (=Pw) while the intensity of the laser beam 30 to be applied to the portion where recording marks should not be formed, i.e., blank region may be predetermined to a sufficiently low base power (=Pb). In this arrangement, the optical recording medium 10 undergoes decomposition and modification of the organic dye contained in the recording layer 21 at the area irradiated with the laser beam 30 having a recording power but undergoes no decomposition and modification of the organic dye and thus forms a blank region at the area irradiated with the laser beam 30 having a base power.

In the optical recording medium 10 according to the present embodiment, since the relationship between the inclination angle θa of the inward wall 33 of the groove 11a and the inclination angle θb of the outward wall 34 of the groove 11a is predetermined to θa>θb as described in connection with FIG. 2, the thickness of the recording layer 21 can be made almost constant inside the groove 11a, making it assured that the recording layer 21 has a desired thickness over a wide area ranging from the inward side to the outward side of the groove 11a. As a result, heat of laser beam 30 emitted during recording can be dissipated toward the reflective layer 22 almost uniformly over an area ranging from inward side to outward side inside the groove 11a to eliminate thermal interference, making it possible to provide a wide power margin even during a high speed recording.

It goes without saying that various changes and modifications can be made in the invention within the scope thereof defined in the claims without being limited to the aforementioned embodiments and these changes and modifications are included in the scope thereof.

For example, the configuration of the optical recording medium 10 shown in FIG. 1 is only an example of the optical recording medium according to the invention and the configuration of the optical recording medium according to the invention is not limited thereto. For example, the protective layer 23 may be omitted so that the adhesive layer 24 is formed directly on the reflective layer. Alternatively, the dummy substrate 12 and the adhesive layer 24 for bonding the dummy substrate 12 maybe omitted. When the dummy substrate 12 and the adhesive layer 24 are omitted, the resulting optical recording medium has a CD-R type structure. In other words, the invention can be applied to CD-R type optical recording media.

Further, the dummy substrate 12 maybe replaced by a laminate of another light-transmitting substrate having a groove and a recording layer and other layers formed on the surface thereof which is laminated on the light-transmitting substrate 11 to provide a structure having a recording surface provided on the both sides thereof. Alternatively, the protective layer 23 may be replaced by a transparent interlayer having a spiral groove on which a recording layer and other layers are provided to provide a structure having two or more recording layers provided on one side thereof. In the case where a plurality of recording surfaces are provided, it is not essential that the profile of groove satisfy the relationship θa>θb for all the recording surfaces. It suffices if at least one of the recording surfaces satisfies the aforementioned relationship.

### EXAMPLE 1

The invention will be further described in the following examples, but the invention should not be construed as being limited thereto.

[Preparation of Samples]

### EXAMPLE 1

Firstly, a photoresist master 200 was subjected to cutting using a cutting device 100 having the configuration shown in FIG. 6. A optical modulation unit 123 was adjusted such that a latent image 203 formed on a photosensitive material layer 202 is allowed to wobble and when the portion corresponding to the center of the amplitude of wobbling is exposed to light, the axis of exposing laser beam 121a is deflected inward at an angle of about 0.00033° with respect to straight line X1 perpendicular to the surface of the photosensitive material layer 202 (θc=approx. 0.00033°). The amplitude W of wobbling was predetermined to about 30 nm. In this arrangement, the angle of deflection (θc+a°) of the exposing laser beam 121a during the exposure of the portion at which the exposing laser beam 121a wobbles most inward was about 0.00034° and the angle of deflection (θc−a°) of the exposing laser beam 121a during the exposure of the portion at which the exposing laser beam 121a wobbles most outward was about 0.00032°. The track pitch was predetermined to about 0.74 μm.

Subsequently, the photoresist master 200 which had been cut was subjected to development or the like to prepare a master for optical recording medium 210. A polycarbonate was then subjected to injection molding using the master for optical recording medium 210 to prepare a disc-shaped light-transmitting substrate 11 made of polycarbonate having a thickness of about 0.6 mm and a diameter of about 120 mm and having a groove 11a and a land 11b formed thereon.

Subsequently, the light-transmitting substrate 11 was mounted on a spin coating device. A solution having a PDS-1861 dye produced by MITSUBISHI CHEMICAL CORPORATION dissolved in a solution of 2-2-3-3-tetrafluoro-1-propanol was then dropped onto the surface of the light-transmitting substrate 11 on the side thereof having the groove 11a formed thereon while the light-transmitting substrate 11 was being rotated so that it was spin-coated on the light-transmitting substrate 11. Thereafter, the coat layer was dried to form a recording layer 21 having a thickness of about 90 nm in the groove 11a.

Subsequently, the light-transmitting substrate 11 having the recording layer 21 formed thereon was mounted on a sputtering device by which a reflective layer 22 made of an alloy of silver (Ag), neodymium (Nd) and copper (Cu) was then formed on the surface of the recording layer 21 to a thickness of about 120 nm.

Subsequently, the light-transmitting substrate 11 having the reflective layer 22 formed thereon was again mounted on the spin coating device. An ultraviolet-curing acrylic resin was then dropped onto the reflective layer 22 while the light-transmitting substrate 11 was being rotated so that it was spin-coated over the reflective layer 22. Thereafter, the coat layer was irradiated with ultraviolet rays so that it was hardened to form a protective layer 23 thereon to a thickness of about 5 μm. An ultraviolet-curing adhesive was then dropped onto the protective layer 23 so that it was spin-coated on the protective layer 23 to form an adhesive layer 24 thereon to a thickness of about 40 μm.

Subsequently, a disc-shaped dummy substrate 12 having a thickness of about 0.6 mm and a diameter of about 120 mm was laminated on the surface of the adhesive layer 24. The laminate thus formed was then irradiated with ultraviolet rays on the dummy substrate side thereof to harden the adhesive layer 24.

In this manner, an optical recording medium sample according to Example 1 was completed.

### EXAMPLE 2

An optical recording medium sample according to Example 2 was prepared in the same manner as in Example 1 except that the optical modulation unit 123 was adjusted in the cutting of the photoresist master 200 such that the axis of the exposing laser beam 121a was deflected inward at an angle of about 0.00016° with respect to straight line X1 perpendicular to the surface of the photosensitive material layer 202 during the exposure of the corresponding to the center of the amplitude of wobbling.

### COMPARATIVE EXAMPLE 1

An optical recording medium sample according to Comparative Example 1 was prepared in the same manner as in Example 1 except that the optical modulation unit 123 was adjusted in the cutting of the photoresist master 200 such that the axis of the exposing laser beam 121a coincided substantially with straight line X1 perpendicular to the surface of the photosensitive material layer 202 during the exposure of the corresponding to the center of the amplitude of wobbling.

### COMPARATIVE EXAMPLE 2

An optical recording medium sample according to Comparative Example 2 was prepared in the same manner as in Example 1 except that the optical modulation unit 123 was adjusted in the cutting of the photoresist master 200 such that the axis of the exposing laser beam 121a was deflected outward at an angle of about 0.00016° with respect to straight line X1 perpendicular to the surface of the photosensitive material layer 202 during the exposure of the corresponding to the center of the amplitude of wobbling.

### COMPARATIVE EXAMPLE 3

An optical recording medium sample according to Comparative Example 3 was prepared in the same manner as in Example 1 except that the optical modulation unit 123 was adjusted in the cutting of the photoresist master 200 such that the axis of the exposing laser beam 121a was deflected outward at an angle of about 0.00033° with respect to straight line X1 perpendicular to the surface of the photosensitive material layer 202 during the exposure of the corresponding to the center of the amplitude of wobbling.

[Evaluation 1 of Properties]

Firstly, the various optical recording medium samples were each mounted on a Type DDU1000 optical disc evaluating device (produced by PULSTEC INDUSTRIAL CO., LTD). While being rotated at a linear speed (reference linear speed) of about 3.5 m/s, the optical recording medium samples were each irradiated with laser beam having a wavelength of about 660 nm through an objective lens having an aperture of about 0.65 on the light incidence surface 13 to record a random signal consisting of 3T to 11T and 14T signals. Referring to the power conditions of laser beam 30, the recording power (Pw) was predetermined to any of 6.8 mW, 7.0 mW, 7.2 mW, 7.4 mW and 7.6 mW and the base power (Pb) was predetermined to 0.7 mW.

Subsequently, the random signal recorded on these optical recording medium samples were each reproduced. Asymmetry was then calculated from the waveform of RF signal (eye pattern) thus obtained. Asymmetry is defined by the following equation:

$$Asym = \frac{\frac{b 1 + b 2}{2} - \frac{a 1 + a 2}{2}}{b 1 - b 2}$$

wherein a1 and a2 represent the reflectance of waveform having the smallest amplitude on the high wavelength side and on the low wavelength side, respectively, and b1 and b2 represent the reflectance of waveform having the greatest amplitude on the high wavelength side and on the low wavelength side, respectively.

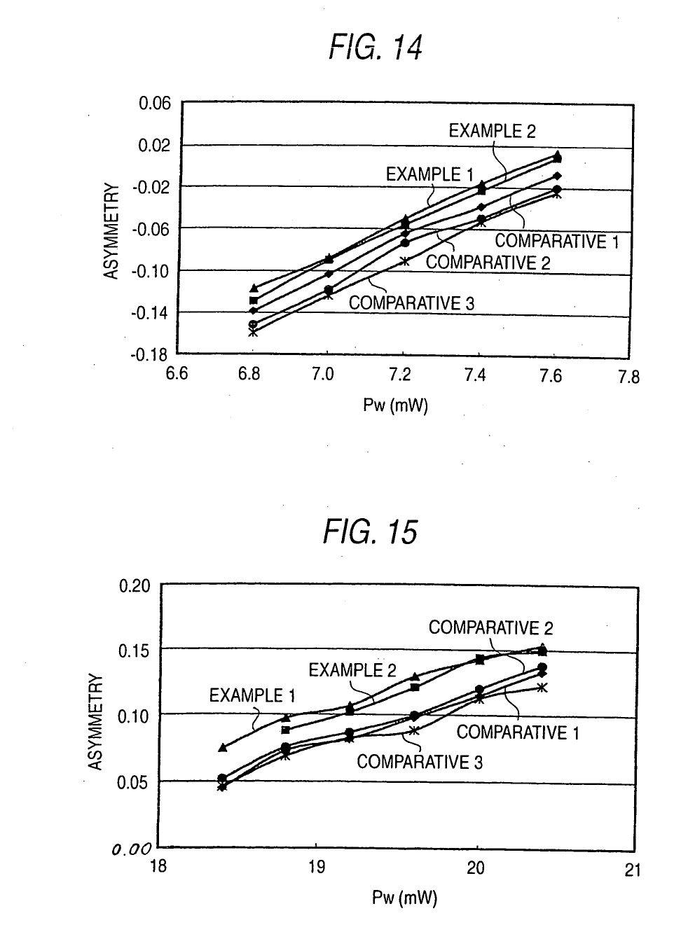

The relationship between the recording power (Pw) and asymmetry of the laser beam 30 is shown in FIG. 14. As shown in FIG. 14, all these optical recording medium samples showed a substantially linear relationship between recording power and asymmetry. Thus, the higher the recording power is used, the greater is asymmetry. This is probably because the organic dye contained in the recording layer 21 undergoes insufficient decomposition and modification at the portion at which the 3T recording mark, which is the shortest mark, is formed and the predetermination of the recording power to a high value causes the decomposition and modification of the organic dye to proceed further at the portion at which the 3T recording mark is formed.

Noting the difference among these optical recording medium samples, the optical recording medium samples of Examples 1 and 2 showed a generally greater asymmetry than the optical recording medium samples of Comparative Examples 1 to 3. This means that even when the same recording power is used, the optical recording medium samples of Examples 1 and 2 show further progress of decomposition and modification of organic dye at the portion at which the 3T recording mark is formed than the optical recording medium samples of Comparative Examples 1 to 3. In other words, the optical recording medium samples of Examples 1 and 2 have a higher recording sensitivity than the optical recording medium samples of Comparative Examples 1 to 3.

[Evaluation 2 of Properties]

Subsequently, using the same optical disc evaluating device, a random signal consisting of 3T to 11T and 14T signals was recorded on the various optical recording medium samples with the recording linear speed predetermined to about 14.0 m/s (four times speed). Referring to the power conditions of laser beam 30, the recording power (Pw) was predetermined to any of 18.4 mW, 18.8 mW, 19.2 mW, 19.6 mW, 20.0 mW and 20.4 mW and the base power (Pb) was predetermined to 0.7 mW.

Subsequently, the random signal recorded on these optical recording medium samples were each reproduced. Asymmetry was then calculated from the waveform of RF signal (eye pattern) thus obtained. At the same time, using a Type DR-3340 DVD decoder (produced by Kenwood Corporation), the number of errors (error count) was measured. The term “number of errors (error count)” as used herein is meant to indicate the maximum number of PI errors counted per 8ECC units.

The relationship between the recording power (Pw) and asymmetry of the laser beam 30 is shown in FIG. 15. As shown in FIG. 15, even when the recording linear speed was as high as about 14.0 m/s (four times speed), the optical recording medium samples of Examples 1 and 2 showed a generally greater asymmetry than the optical recording medium samples of Comparative Examples 1 to 3. In other words, the optical recording medium samples of Examples 1 and 2 showed a higher recording sensitivity than the optical recording medium samples of Comparative Examples 1 to 3 even during high speed recording.

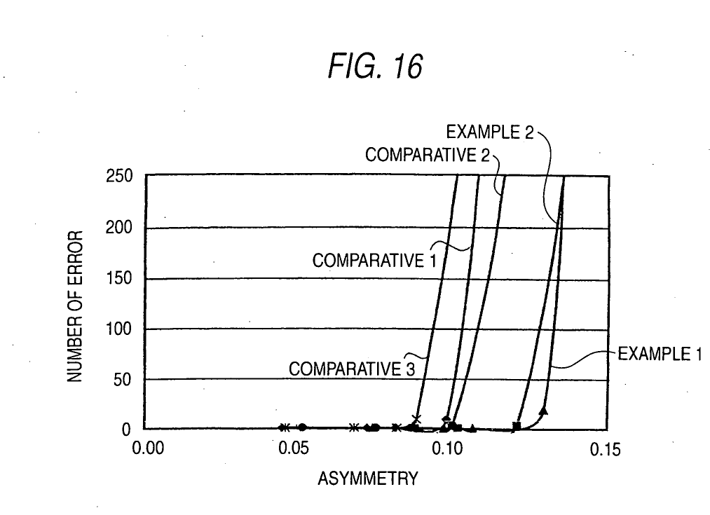

The relationship between asymmetry and error rate thus obtained is shown in FIG. 16. As shown in FIG. 16, the optical recording medium samples of Comparative Examples 1 to 3 showed a sudden rise of error rate when the asymmetry was about 8% or more. On the contrary, the optical recording medium samples of Examples 1 and 2 showed a sufficiently reduced error rate even when the asymmetry was as high as about 13%. In order to perform high speed recording, it is necessary that the recording power of laser beam 30 be predetermined high, causing remarkable occurrence of thermal interference between recording marks. However, it is made obvious that the optical recording medium samples of Examples 1 and 2 show reduced occurrence of errors even if the asymmetry is high, that is, the recording power is raised. It was thus confirmed that the optical recording medium samples of Examples 1 and 2 undergo little thermal interference during high speed recording and allow a wide power margin as compared with the optical recording medium samples of Comparative Examples 1 to 3.

As mentioned above, the invention can provide a high recording sensitivity and a wide power margin. This effect can be remarkably exerted particularly during high speed recording. Accordingly, the invention can provide an optical recording medium suitable for high speed recording. Further, since this effect can be realized by properly adjusting the angle of incidence of exposing laser beam during the cutting of the photoresist master, the process of the invention causes no cost rise as compared with the related art process.

1. An optical recording medium comprising:
a substrate having a spiral groove formed on at least one surface thereof; and
a recording layer containing an organic dye formed on the surface of the substrate on the side thereof where the groove is formed,
wherein the average inclination angle of the wall of the groove on the inward side thereof is greater than that of the wall of the groove on the outward side thereof.

2. The optical recording medium as defined in claim 1, further comprising a reflective layer provided on the side of the substrate opposite the recording layer.

3. The optical recording medium as defined in claim 1 or 2, wherein the groove wobbles with a predetermined amplitude and the inclination angle of the wall of the groove on the inward side thereof is greater than that of the wall of the groove on the outward side thereof at the center of the amplitude.

4. The optical recording medium as defined in claim 3, wherein the inclination angle of the wall of the groove on the inward side thereof is greater than that of the wall of the groove on the outward side thereof at the portion where the groove wobbles most outward.

5. A process for the production of an optical recording medium comprising:
a first step of exposing a photoresist master to light with the axis of exposing laser beam inclined toward the inward side of the photoresist master on the average;
a second step of transferring the pattern thus formed on the photoresist master by exposure to prepare a master for optical recording medium;
a third step of transferring the pattern formed on the master for optical recording medium to prepare a substrate having a groove; and
a fourth step of spin-coating a solution containing an organic dye onto the surface of the surface of the substrate on the side thereof having the groove formed thereon.

6. The process for the production of an optical recording medium as defined in claim 5, wherein the average angle of deflection of the exposing laser beam toward the inward side of the photoresist master at the first step is predetermined to be from greater than 0° to not greater than 0.00045°.

7. The process for the production of an optical recording medium as defined in claim 6, wherein the variation of radiation angle of the exposing laser beam at the first step causes the formation of an exposure pattern wobbling with a predetermined amplitude and the angle of deflection of the exposing laser beam toward the inward side of the photoresist master is predetermined to be from greater than 0° to not greater than 0.00045° during the exposure of the portion of the exposure pattern corresponding to the center of the amplitude to light.

8. The process for the production of an optical recording medium as defined in claim 7, wherein the angle of deflection of the exposing laser beam toward the inward side of the photoresist master is predetermined to be from greater than 0° to not greater than 0.00045° during the exposure of the portion of the photoresist master corresponding to the portion at which the groove wobbles most outward.

9. A process for the production of an optical recording medium comprising:
a first step of preparing a substrate having a spiral groove using a master for optical recording medium having a spiral raised pattern wherein the average angle of inclination of the wall of the raised pattern on the inward side thereof is greater than that of the wall of the raised pattern on the outward side thereof; and
a second step of spin-coating a solution containing an organic dye onto the surface of the surface of the substrate on the side thereof having the groove formed thereon.

10. A master for optical recording medium for use in the preparation of a substrate for optical recording medium, wherein there is provided a spiral raised pattern on the surface thereof and the average angle of inclination of the wall of the raised pattern on the inward side thereof is greater than that of the wall of the raised pattern on the outward side thereof.

11. A process for the production of a master for optical recording medium comprising:
a first step of exposing a photoresist master to light with the axis of exposing laser beam inclined toward the inward side of the photoresist master on the average; and
a second step of transferring the pattern thus formed on the photoresist master by exposure to prepare a master for optical recording medium.
